(19) United States
(12) Patent Application Publication
(10) Pub. No.: US 2019/0377577 A1
(43) Pub. Date: Dec. 12, 2019

(54) DYNAMIC ADJUSTMENT OF ISSUE-TO-ISSUE DELAY BETWEEN DEPENDENT INSTRUCTIONS

(71) Applicant: INTERNATIONAL BUSINESS MACHINES CORPORATION, Armonk, NY (US)

(72) Inventors: Dongkook PARK, Austin, TX (US); Ehsan FATEHI, Austin, TX (US); Brian W. THOMPTO, Austin, TX (US); Brian D. BARRICK, Pflugerville, TX (US)

(21) Appl. No.: 16/001,180

(22) Filed: Jun. 6, 2018

(51) Int. Cl. G06F 9/30; G06F 9/38; G06F 9/32

(52) U.S. Cl. CPC G06F 9/30145; G06F 9/321; G06F 9/3826; G06F 9/3836

(57) ABSTRACT

Systems, methods, and computer-readable media are described for dynamically adjusting the issue-to-issue delay among instructions in a dependency chain so as to minimize instruction issue delay due to write-back and/or broadcast collisions. The issue-to-issue delay between instructions is dynamically adjusted on-the-fly by disabling and enabling bypassing, thereby allowing the ISU to adapt to different instruction characteristics of various workloads executing on a processor, and as a result, minimize potential ISU broadcast and/or write-back collisions.

### BACKGROUND

The present invention relates to instruction execution generally, and more particularly, to issue-to-issue delays between dependent instructions.

Typical workloads include different instruction mixes as well as source dependencies among instructions. Issue-to-issue delays between dependent instructions are fixed in the microarchitectures of conventional processors. Fixed issue-to-issue delays, however, suffer from a number of drawbacks, technical solutions to which are described herein.

### SUMMARY

In one or more example embodiments, a method for dynamically adjusting an issue-to-issue delay mode of an instruction sequencing unit is disclosed. The method includes initializing the issue-to-issue delay mode to a bypassing mode. The method further includes identifying a plurality of instructions in an issue queue and determining, for each of the plurality of instructions, whether the instruction is able to issue in the bypassing mode. The method additionally includes initializing a counter to a predetermined value, decrementing the counter for each instruction able to issue in the bypassing mode, and incrementing the counter for each instruction not able to issue in the bypassing mode. The method finally includes determining that the counter is greater than or equal to a threshold value and switching the issue-to-issue delay mode to a non-bypassing mode.

In one or more other example embodiments, a system for dynamically adjusting an issue-to-issue delay mode of an instruction sequencing unit is disclosed. The system includes at least one processor that includes an instruction sequencing unit (ISU). The ISU includes various hardware logic modules configured to perform various operations. In particular, the ISU includes instruction issue behavior monitoring logic configured to initialize the issue-to-issue delay mode of the ISU to a bypassing mode, identify a plurality of instructions in an issue queue, and determine, for each of the plurality of instructions, whether the instruction is able to issue in the bypassing mode. The ISU further includes issue-to-issue delay adjustment logic configured to initialize a counter to a predetermined value, decrement the counter for each instruction able to issue in the bypassing mode, and increment the counter for each instruction not able to issue in the bypassing mode. The issue-to-issue delay adjustment logic is further configured to determine that the counter is greater than or equal to a threshold value and switch the issue-to-issue delay mode to a non-bypassing mode.

In one or more other example embodiments, a computer program product for dynamically adjusting an issue-to-issue delay mode of an instruction sequencing unit is disclosed. The computer program product includes a non-transitory storage medium readable by a processing circuit, the storage medium storing instructions executable by the processing circuit to cause a method to be performed. The method includes initializing the issue-to-issue delay mode to a bypassing mode. The method further includes identifying a plurality of instructions in an issue queue and determining, for each of the plurality of instructions, whether the instruction is able to issue in the bypassing mode. The method additionally includes initializing a counter to a predetermined value, decrementing the counter for each instruction able to issue in the bypassing mode, and incrementing the counter for each instruction not able to issue in the bypassing mode. The method finally includes determining that the counter is greater than or equal to a threshold value and switching the issue-to-issue delay mode to a non-bypassing mode.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic hybrid data flow/block diagram illustrating dynamic adjustment of issue-to-issue delay between dependent instructions in accordance with example embodiments.

FIG. 2 is a process flow diagram of an illustrative method for monitoring instruction issue behavior in accordance with one or more example embodiments.

FIG. 3 is a process flow diagram of an illustrative method for dynamically adjusting an issue-to-issue delay mode in accordance with one or more example embodiments.

FIG. 4 is a process flow diagram of an illustrative method for resetting the issue-to-issue delay mode in accordance with one or more example embodiments.

FIG. 5 is a schematic diagram of an illustrative computing device configured to implement one or more example embodiments.

### DETAILED DESCRIPTION

Example embodiments relate to, among other things, systems, methods, computer-readable media, techniques, and methodologies for dynamically adjusting the issue-to-issue delay for a group of instructions, where at least some of the instructions have a source dependency there between. In accordance with example embodiments, the issue-to-issue delay between instructions can be dynamically adjusted on-the-fly by enabling and disabling a bypassing mode such that an instruction sequencing unit (ISU) can adapt to different instruction characteristics of various workloads running on a processor. Instructions in an issue queue may be monitored to determine an instruction mix of the instructions. Determining the instruction mix may include determining various characteristics of the instructions including, for example, the number of vector operations, the number of scalar operations, the ratio between vector and scalar operations, the number of floating point instructions, the number of integer instructions, the ratio between floating point and integer instructions, the number/ratio of multi-cycle operations, and so forth.

In accordance with example embodiments, the instruction mix can be used to determine whether to enable or disable an instruction bypassing mode. More specifically, for a particular class of instructions of interest, a first counter may be incremented or decremented based on whether each instruction could be issued with bypassing or whether some additional delay was experienced that prevented bypassing. In particular, the first counter (which may first be initialized to some predetermined value) may be incremented for each instruction in the instruction class of interest that is able to bypass and decremented for each instruction that is unable to bypass. When the first counter reaches a threshold value, the issue-to-issue delay mode may be switched from the bypassing mode (which may be an initial default mode) to a non-bypassing mode. Switching from the bypassing mode to the non-bypassing mode may increase the issue-to-issue delay, which may represent a minimum delay required between a back-to-back issuance of two instructions with a source dependency. A source dependency may exist between instructions when a source register of an instruction is the target register of another older instruction. In such a scenario, the instruction cannot be issued until the older instruction writes the results into the target register. For instance, a non-bypassing issue-to-issue delay between vector floating point operations may typically be 7 cycles. However, with bypassing this issue-to-issue delay may be reduced to 5 cycles, for example.

After the issue-to-issue delay mode has been switched from the bypassing mode to the non-bypassing mode, a second counter (which also may be initialized to some predetermined initial value) may be incremented for each instruction cycle in which the issue-to-issue delay mode is in the non-bypassing mode until the second counter reaches a threshold reset value, at which point, the issue-to-issue delay mode may again be switched back to the bypassing mode. In addition to switching back to the bypassing mode when the second counter reaches the threshold reset value, the first counter may be set to a reset counter value, which may be the same as or different from the initial value to which the first counter was initialized.

Example embodiments provide various technical features, technical effects, and/or improvements to computer technology. Specifically, example embodiments provide technological improvements to the performance of a processor in handling the processing of workloads having different instruction mixes. In particular, example embodiments provide for an improved processor microarchitecture that addresses the drawbacks associated with the fixed issue-to-issue delays of conventional processor microarchitectures. While fixed issue-to-issue delay may be suitable for certain workloads, it can lead to instruction starvation for other workloads such as those that include a mix of vector and scalar instructions; integer and floating point instructions; and/or multi-cycle instructions. Instruction starvation may refer to an instruction being stuck in the issue queue for a long period of time without issuing. This may result from any of a variety of factors including, for example, conflicts with other instructions, resource unavailability, and so forth.

Typical server workloads include many applications, each having a different set of characteristics. For example, the ratio of vector instructions to scalar instructions and/or the ratio of floating point instructions to integer instructions may vary across workloads. Further, some workloads may include instructions with long-chained source dependencies, while other workloads may not. Such diversity of instruction mix among workloads can lead to different levels of resource utilization in the processor pipeline such as the issue queue, and with a fixed issue-to-issue delay, the influx ratio of instructions into the issue queue cannot be adjusted, which in turn, may result in contention issues and instruction starvation in the issue queue.

In conventional microarchitectures that utilize fixed issue-to-issue delays, multi-cycle execution latency operations may collide and prevent one another from issuing due to broadcast and write-back collisions. In particular, multi-cycle operations having different cycle lengths may attempt to issue at the same time under a fixed issue-to-issue delay scenario, which may result in collision. Moreover, workloads that include multi-cycle operations of different cycle lengths that are also a mixture of scalar and vector instructions, for example, compound the problem. Some conventional microarchitectures prevent or attempt to minimize the risk of broadcast and write-back collisions by creating additional hazards between instructions. This approach, however, prevents older instructions from issuing in a timely/reasonable manner (instruction starvation), which results in severe performance degradation.

Example embodiments minimize instruction issue delay due to write-back and/or broadcast collisions by dynamically adjusting the issue-to-issue delay among instructions in a dependency chain. In particular, example embodiments include technical features that dynamically adjust the issue-to-issue delay between instructions on-the-fly by disabling and enabling bypassing, thereby allowing the ISU to adapt to different instruction characteristics of various workloads executing on a processor, and as a result, provide the technical effect of minimizing potential ISU broadcast and/or write-back collisions. Thus, example embodiments provide an improvement to computer technology—specifically an improvement to processor microarchitecture—by minimizing the ISU broadcast and write-back collisions that are commonly associated with conventional microarchitectures that utilize a fixed issue-to-issue delay, thereby improving processor pipeline performance.

Conventional microarchitectures that utilize a fixed issue-to-issue delay may, for example, always issue instructions in bypassing mode or always disable bypassing. Neither of these options, however, is viable because, as previously noted, either option increases the number of write-back and/or broadcast collisions that occur, which in turn, leads to performance degradation. Example embodiments represent a technological improvement over the conventional solutions of always bypassing or never bypassing by providing an optimal solution that dynamically switches between the bypassing and non-bypas sing modes depending on the mix of instructions executing in the processor pipeline, and that as a consequence, preserves processor pipeline performance.

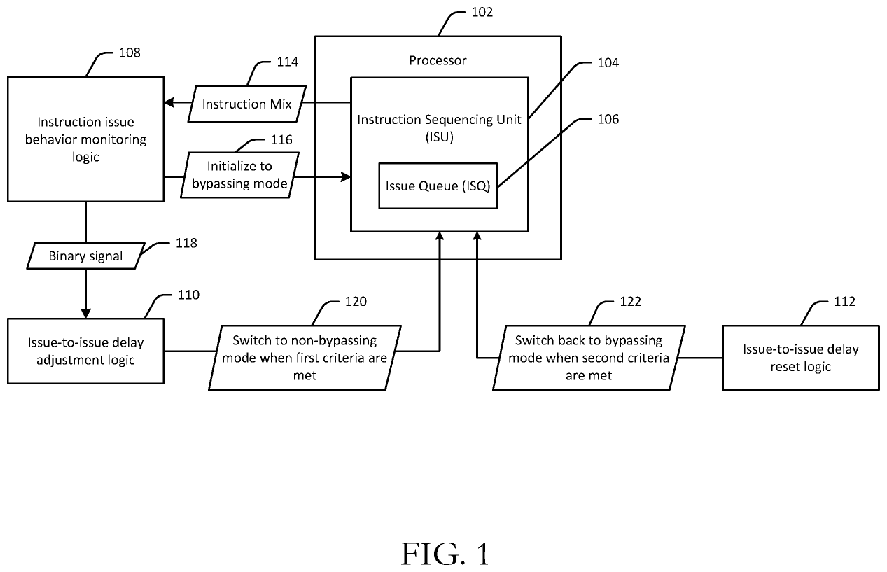

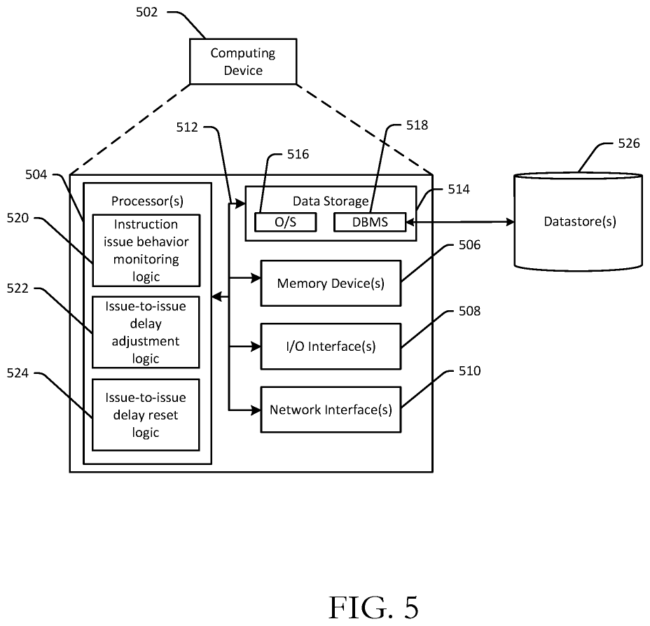

Various illustrative methods and corresponding data structures associated therewith will now be described. It should be noted that each operation of the methods 200-400 may be performed by one or more of the logic modules or the like depicted in FIG. 1 or 5, whose operation will be described in more detail hereinafter. These logic modules may be implemented in any combination of hardware, software, and/or firmware. In certain example embodiments, these logic modules may be hardware logic. In other example embodiments, one or more of these modules may be program modules implemented, at least in part, as software and/or firmware modules that include computer-executable instructions that when executed by a processing circuit cause one or more operations to be performed. A system or device described herein as being configured to implement example embodiments may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

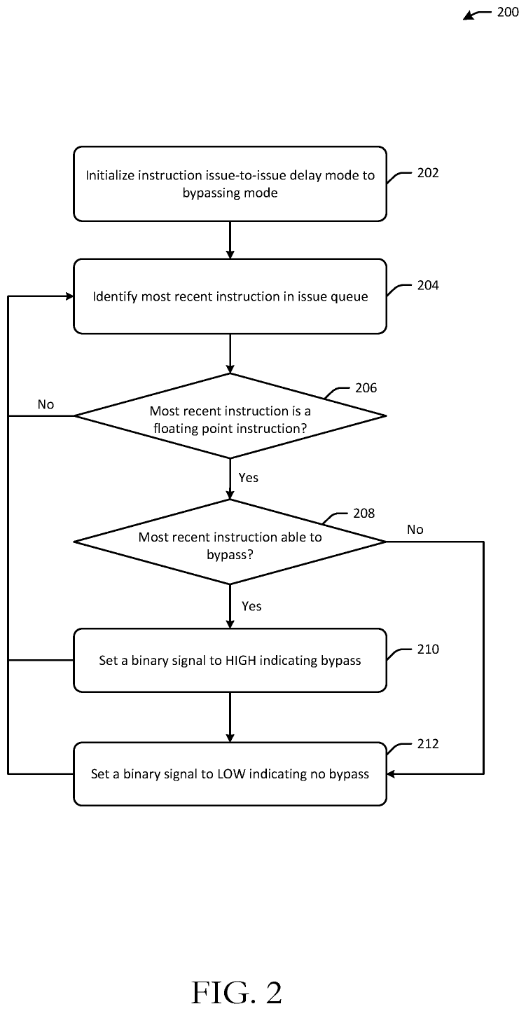

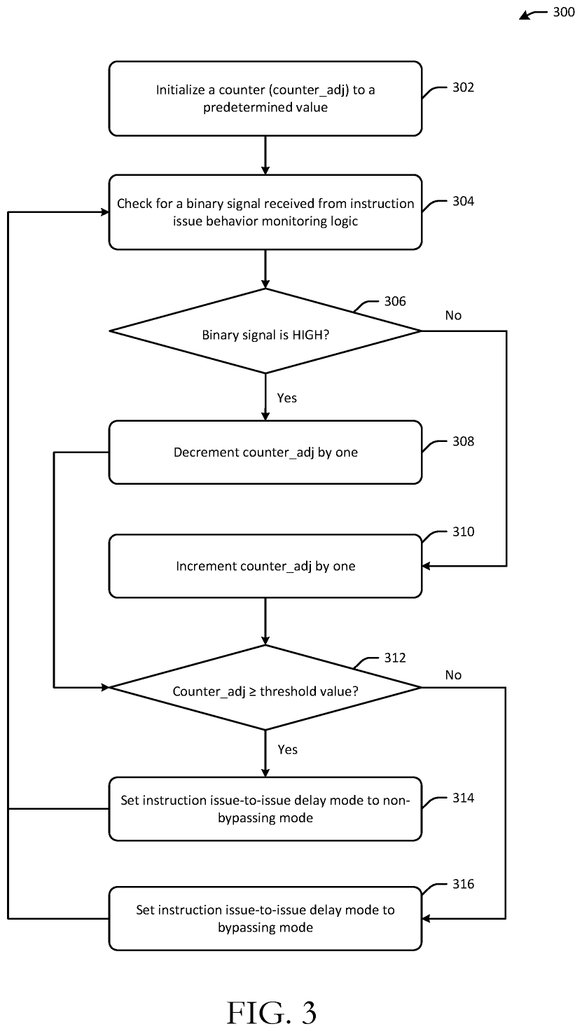

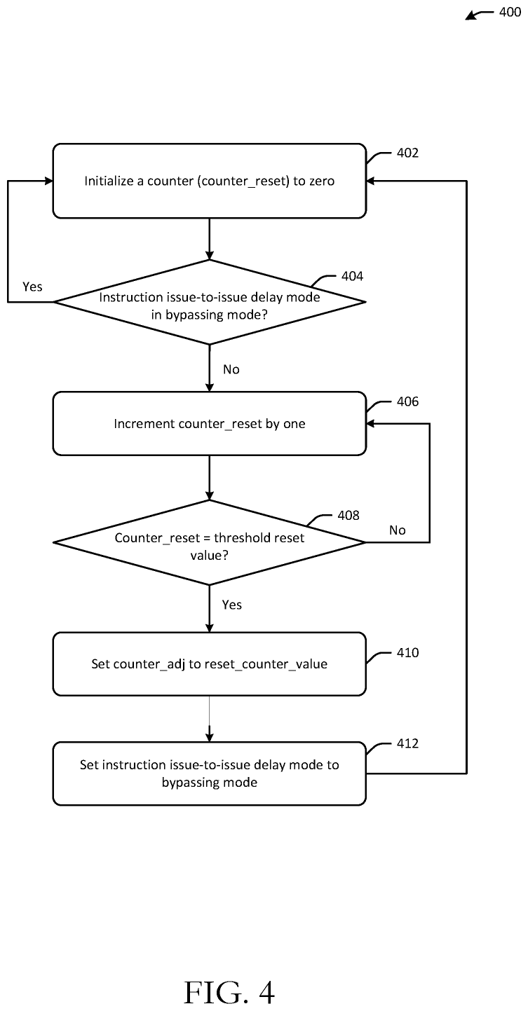

FIG. 1 is a schematic hybrid data flow/block diagram illustrating dynamic adjustment of issue-to-issue delay between dependent instructions. FIG. 2 is a process flow diagram of an illustrative method 200 for monitoring instruction issue behavior; FIG. 3 is a process flow diagram of an illustrative method 300 for dynamically adjusting an issue-to-issue delay mode; and FIG. 4 is a process flow diagram of an illustrative method 400 for resetting the issue-to-issue delay mode. FIGS. 2, 3, and 4 will each be described in conjunction with FIG. 1 hereinafter.

Referring first to FIG. 1, an illustrative computer processor 102 in accordance with example embodiments is depicted. The processor 102 may include one or more cores (not depicted), and may further include an ISU 104. The ISU 104 may be configured to determine and control the order in which instructions are executed by the processor 102. That is, the ISU 104 may be configured to determine and control the sequence in which instructions undergo the fetch-decode-execute instruction cycle. In certain example embodiments, the ISU 104 may be configured to permit out-of-order instruction execution as well as concurrent and/or parallel execution of instructions. The ISU 104 may include or otherwise communicate with an issue queue (ISQ) 106 that includes a sequence of instructions awaiting issue.

FIG. 1 also depicts various logic modules that together enable the technical effect of dynamic switching between a bypassing issue-to-issue delay mode and a non-bypassing issue-to-issue delay mode provided by example embodiments. These logic modules may include, for example, instruction issue behavior monitoring logic 108, issue-to-issue delay adjustment logic 110, and issue-to-issue delay reset logic 112. The operation of these logic modules will be described in more detail hereinafter in reference to FIGS. 2, 3, and 4, respectively. In certain example embodiments, these logic modules may represent hardware logic. However, it should be appreciated that the logic modules 108, 110, and 112 may be, in certain example embodiments, software and/or firmware program modules that reside on any suitable computer-readable storage medium and may be executable by the processor 102 and/or by one or more other processors to enable the dynamic switching of the issue-to-issue delay mode disclosed herein in accordance with example embodiments.

Referring now to FIG. 2 in conjunction with FIG. 1, at block 202 of the method 200, the instruction issue behavior monitoring logic 108 may execute to initialize 116 the issue-to-issue delay mode of the ISU 104 to the bypassing mode. As previously described, the issue-to-issue delay between instructions may be reduced in the bypassing mode as compared the typical issue-to-issue delay for such instructions (the non-bypassing mode).

After initializing to the bypassing mode, the instruction issue behavior monitoring logic 108 may execute to monitor the instruction mix 114 of instructions in the ISQ 106. More specifically, in certain example embodiments, at block 204 of the method 200, the instruction issue behavior monitoring logic 108 may execute to identify a most recent instruction in the ISQ 106. Then, at block 206 of the method 200, the instruction issue behavior monitoring logic 108 may execute to make a determination as to whether the most recent instruction is among a class of instructions of interest. In the example implementation depicted in FIG. 2, for example, the instruction issue behavior monitoring logic 108 may determine if the most recent instruction is a floating point instruction. It should be appreciated that floating point instructions are merely described for illustrative purposes. In particular, the instruction issue behavior monitoring logic 108 may monitor the ISQ 106 for any type of instructions of interest including, but not limited to, multi-cycle instructions, vector instructions, scalar instructions, integer instructions, or the like, as well as, ratios of different types of instructions.

In response to a negative determination at block 206—indicating that the most recent instruction identified from the ISQ 106 is not an instruction of interest—the method 200 may again proceed from block 204, where a next instruction in the ISQ 106 may be identified. In response to a positive determination at block 206, however, the instruction issue behavior monitoring logic 108 may execute at block 208 of the method 200 to determine whether the instruction of interest was able to issue in the bypassing mode. More specifically, the instruction issue behavior monitoring logic 108 may determine at block 208 of the method 200 whether the instruction of interest could be issued with bypassing or whether the instruction encountered some additional delay due to contention, for example, and thus was unable to bypass. In response to a positive determination at block 208 indicating that the instruction of interest was able to bypass, the instruction issue behavior monitoring logic 108 may execute at block 210 of the method 200 to set a binary signal 118 to HIGH to indicate that the instruction was able to bypass. On the other hand, in response a negative determination at block 208 indicating that the instruction of interest was not able to bypass, the instruction issue behavior monitoring logic 108 may execute at block 212 of the method 200 to set the binary signal 118 to LOW to indicate that the instruction was not able to bypass. It should be appreciated that these may be reversed in certain example embodiments such that a LOW binary signal may indicate successful bypassing whereas a HIGH signal may indicate an inability to bypass.

From each of blocks 210 and 212, the method 200 may return to block 204 and may iteratively execute to determine, for each instruction of interest among a group of instructions in the ISQ 106, whether the instruction was or was not able to bypass. The instruction issue behavior monitoring logic 108 may set the respective binary signal 118 for each such instruction to either HIGH or LOW to indicate whether the corresponding instruction was able to issue in bypassing mode or was not able to bypass. The instruction issue behavior monitoring logic 108 may be configured to send the collection of binary signals that are indicative of the bypassing/non-bypassing of a group of instructions of interest in the ISQ 106 to the issue-to-issue delay adjustment logic 110. The issue-to-issue delay adjustment logic 110 may be configured to adjust a counter based on the binary signals that are received in order to dynamically switch to the non-bypassing mode based on the instruction mix 114. Functionality of the issue-to-issue delay adjustment logic 110 will be described in more detail hereinafter in reference to the illustrative method 300 of FIG. 3.

Referring now to FIG. 3 in conjunction with FIG. 1, at block 302 of the method 300, the issue-to-issue delay adjustment logic 110 may execute to initialize a counter (counter_adj) to a predetermined value. In certain example embodiments, counter_adj may be initialized to zero. In other example embodiments, counter_adj may be initialized to some non-zero value that may depend, at least in part, on the instruction mix 114. More specifically, the non-zero value to which counter_adj may be initialized may depend, at least in part, on the number and/ratio of a particular type of instruction (e.g., vector floating point operation) reflected in the instruction mix 114.

At block 304 of the method 300, the issue-to-issue delay adjustment logic 110 may execute to monitor for a binary signal 118 received from the instruction issue behavior monitoring logic 108. Upon receipt of a binary signal 118, the issue-to-issue delay adjustment logic 110 may execute to determine whether the binary signal 118 is set to HIGH, indicative of an instruction of interest being able to successfully issue in the bypassing mode.

In response to a positive determination at block 306 indicative of an instruction being able to bypass, the issue-to-issue delay adjustment logic 110 may execute at block 308 of the method 300 to decrement counter_adj by one. Conversely, in response to a negative determination at block 306 indicative of an instruction not being able to bypass, the issue-to-issue delay adjustment logic 110 may execute at block 310 of the method 300 to increment counter_adj by one.

Following each of blocks 308 and 310, the issue-to-issue delay adjustment logic 110 may execute at block 312 of the method 300 to determine whether a current value of counter_adj is greater than or equal to a threshold mode switch value. In response to a positive determination at block 312, the issue-to-issue delay adjustment logic 108 may execute at block 314 of the method 300 to set/switch 120 the instruction issue-to-issue delay mode to the non-bypassing mode. On the other hand, in response to a negative determination at block 312, the issue-to-issue delay adjustment logic 110 may execute at block 316 of the method 300 to set the instruction issue-to-issue delay mode to the bypassing mode. It should be appreciated that the bypassing mode may be the initial default mode, and thus, until the first instance that counter_adj reaches the threshold switch value after initialization of the issue-to-issue delay mode, the operation at block 316 may be performed but may produce no change in the issue-to-issue delay mode or may not be performed at all.

From each of blocks 314 and 316, the method 300 may return to block 304, where the issue-to-issue delay adjustment logic 110 may continue to monitor for receipt of binary signals from the instruction issue behavior monitoring logic 108 and increment or decrement counter_adj based on whether corresponding binary signals indicate successful or unsuccessful instruction bypassing. In this manner, the issue-to-issue delay adjustment logic 110 may utilize counter_adj to track how many instructions are able to successfully bypass in the bypassing mode versus how many instructions are not able to bypass due to, for example, broadcast and/or write-back collisions. As more and more instructions are not able to bypass—which may indicate a high number of collisions—counter_adj is continually incremented upwards to bring it closer and closer to the threshold switch value. The threshold switch value may thus represent a threshold number of instructions not being able to bypass that is indicative of an undesirable number of collisions and an undesirable level of processor performance. After the is sue-to-issue delay mode is switched 120 from the bypassing mode to the non-bypassing mode, the issue-to-issue delay reset logic 112 may execute to determine when to switch the mode back to the bypassing mode. Functionality of the issue-to-issue delay reset logic 112 will be described in more detail hereinafter in reference to the illustrative method 400 of FIG. 4.

Referring now to FIG. 4 in conjunction with FIG. 1, at block 402 of the method 400, the issue-to-issue delay reset logic 112 may execute to initialize a counter (counter_reset) to zero or some other selected value. At block 404 of the method 400, the issue-to-issue delay reset logic 112 may execute to determine whether the instruction issue-to-issue delay mode is currently set to the bypassing mode. If it is (a positive determination at block 404), then the method may return to block 402 and re-initialize counter_reset. On the other hand, in response to a negative determination at block 404—indicating that the issue-to-issue delay mode is set to the non-bypassing mode, the issue-to-is sue delay reset logic 112 may execute at block 406 of the method 400 to increment counter_reset by one.

From block 406, the method 400 may proceed to block 408, where the issue-to-is sue delay reset logic 112 may execute to determine whether counter_reset equals a threshold reset value. In response to a negative determination at block 408, the method 400 may return to block 406, where counter_reset may again be incremented by one. In this manner, counter_reset may be incremented for each instruction cycle in which the issue-to-issue delay mode is in the non-bypassing mode until counter_reset reaches the threshold reset value.

When counter_reset equals the threshold reset value (a positive determination at block 408), the issue-to-issue delay reset logic 112 may execute at block 410 of the method 400 to set counter_adj to a reset counter value. The reset counter value to which counter_adj is set at block 410 may be an intermediate value between zero and the threshold switch value described in relation to the illustrative method 300 of FIG. 3. Then, at block 412 of the method 400, the issue-to-issue delay reset logic 112 may execute to set/switch 122 the issue-to-issue delay mode back to the bypassing mode. From block 412, the method 400 may return to block 402 where counter_reset may be reinitialized to zero. Setting counter_adj to an intermediate reset counter value as part of switching back to the bypassing mode rather than re-initializing counter_adj to zero accounts for some portion of instructions that would not have been able to bypass even if the issue-to-issue delay mode was set to the bypassing mode rather than the non-bypassing mode.

The illustrative method 400 of FIG. 4 represents example logic for resetting the issue-to-issue delay mode back to the bypassing mode from the non-bypassing mode. In other example embodiments, alternative logic implementations may be employed to determine when to reset the issue-to-issue delay mode. For instance, in certain example embodiments, if the issue-to-issue delay mode has been set to the non-bypassing mode, the instruction issue behavior monitoring logic 108 may continue to track, for each instruction of interest, whether the instruction would have been able to bypass or not if the issue-to-issue delay mode was in the bypassing mode. The instruction issue behavior monitoring logic 108 may thus continue to increment and decrement counter_adj based on whether corresponding instructions would have been able to bypass if the issue-to-issue delay mode was set to the bypassing mode. When counter_adj reaches a threshold switch value, the instruction issue behavior monitoring logic 108 may notify the issue-to-issue delay reset logic 112, which in turn, may switch the issue-to-issue delay mode back to the bypassing mode. The threshold switch value in this alternative reset logic implementation may a different value than the threshold switch value used in the illustrative method 200 of FIG. 2 to determine whether the issue-to-issue delay mode should be switched to the non-bypassing mode. For instance, the threshold switch value in this alternative reset logic implementation may be less than the threshold switch value of FIG. 2.

In yet another alternative implementation of the reset logic, the criticality of instructions in the ISQ 106 may be taken into account. For instance, while in the non-bypassing mode, the criticality of each instruction may be assessed, and when the number of instructions deemed critical reaches a threshold value, the issue-to-issue delay mode may be switched back to the bypassing mode. Alternatively, if a critical instruction is encountered in the ISQ 106, the mode may automatically switch back to the bypassing mode. In certain example embodiments, the mode may switch to the bypassing mode for each critical instruction, and may be switched back to the non-bypassing mode until the criteria of the reset logic of FIG. 4 or of the alternative implementation described above is met for switching the mode back to the bypassing mode.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

FIG. 5 is a schematic diagram of an illustrative computing device 502 configured to implement one or more example embodiments of the disclosure. The computing device 502 may be any suitable device including, without limitation, a server, a personal computer (PC), a tablet, a smartphone, a wearable device, a voice-enabled device, or the like. While any particular component of the computing device 502 may be described herein in the singular, it should be appreciated that multiple instances of any such component may be provided, and functionality described in connection with a particular component may be distributed across multiple ones of such a component.

Although not depicted in FIG. 5, the computing device 502 may be configured to communicate with one or more other devices, systems, datastores, or the like via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device 502 may include one or more processors (processor(s)) 504, one or more memory devices 506 (generically referred to herein as memory 506), one or more input/output (“I/O”) interface(s) 508, one or more network interfaces 510, and data storage 514. The computing device 502 may further include one or more buses 512 that functionally couple various components of the computing device 502.

The bus(es) 512 may include at least one of a system bus, a memory bus, an address bus, or a message bus, and may permit the exchange of information (e.g., data (including computer-executable code), signaling, etc.) between various components of the computing device 502. The bus(es) 512 may include, without limitation, a memory bus or a memory controller, a peripheral bus, an accelerated graphics port, and so forth. The bus(es) 512 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 506 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 506 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 506 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 514 may include removable storage and/or non-removable storage including, but not limited to, magnetic storage, optical disk storage, and/or tape storage. The data storage 514 may provide non-volatile storage of computer-executable instructions and other data. The memory 506 and the data storage 514, removable and/or non-removable, are examples of computer-readable storage media (CRSM) as that term is used herein.

The data storage 514 may store computer-executable code, instructions, or the like that may be loadable into the memory 506 and executable by the processor(s) 504 to cause the processor(s) 504 to perform or initiate various operations. The data storage 514 may additionally store data that may be copied to memory 506 for use by the processor(s) 504 during the execution of the computer-executable instructions. Moreover, output data generated as a result of execution of the computer-executable instructions by the processor(s) 504 may be stored initially in memory 506 and may ultimately be copied to data storage 514 for non-volatile storage.

More specifically, the data storage 514 may store one or more operating systems (O/S) 516; one or more database management systems (DBMS) 518 configured to access the memory 506 and/or one or more external datastores 526; and one or more program modules, applications, engines, managers, computer-executable code, scripts, or the like. In those example embodiments in which the logic modules described earlier are implemented in software and/or firmware, the modules may be stored in data storage 514 and may include computer-executable instructions (e.g., computer-executable program code) that may be loaded into the memory 506 for execution by one or more of the processor(s) 504 to perform any of the operations described earlier in connection with correspondingly named modules.

Although not depicted in FIG. 5, the data storage 514 may further store various types of data utilized by components of the computing device 502 (e.g., data stored in the datastore(s) 526). Any data stored in the data storage 514 may be loaded into the memory 506 for use by the processor(s) 504 in executing computer-executable instructions. In addition, any data stored in the data storage 514 may potentially be stored in the external datastore(s) 526 and may be accessed via the DBMS 518 and loaded in the memory 506 for use by the processor(s) 504 in executing computer-executable instructions.

The processor(s) 504 may be configured to access the memory 506 and execute computer-executable instructions loaded therein. For example, the processor(s) 504 may be configured to execute computer-executable instructions of the various program modules, applications, engines, managers, or the like of the computing device 502 to cause or facilitate various operations to be performed in accordance with one or more embodiments of the disclosure. In certain example embodiments, the processor(s) 504 may include hardware logic modules such as instruction issue behavior monitoring logic 520, issue-to-issue delay adjustment logic 522, and issue-to-issue delay reset logic 524. These hardware logic components may be configured to perform any of the operations described earlier in connection with correspondingly named modules.

The processor(s) 504 may include any suitable processing unit capable of accepting data as input, processing the input data in accordance with stored computer-executable instructions, and generating output data. The processor(s) 504 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 504 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 504 may be capable of supporting any of a variety of instruction sets.

Referring now to other illustrative components depicted as being stored in the data storage 514, the O/S 516 may be loaded from the data storage 514 into the memory 506 and may provide an interface between other application software executing on the computing device 502 and hardware resources of the computing device 502. More specifically, the O/S 516 may include a set of computer-executable instructions for managing hardware resources of the computing device 502 and for providing common services to other application programs. In certain example embodiments, the O/S 516 may include or otherwise control the execution of one or more of the program modules, engines, managers, or the like depicted as being stored in the data storage 514. The O/S 516 may include any operating system now known or which may be developed in the future including, but not limited to, any server operating system, any mainframe operating system, or any other proprietary or non-proprietary operating system.

The DBMS 518 may be loaded into the memory 506 and may support functionality for accessing, retrieving, storing, and/or manipulating data stored in the memory 506, data stored in the data storage 514, and/or data stored in external datastore(s) 526. The DBMS 518 may use any of a variety of database models (e.g., relational model, object model, etc.) and may support any of a variety of query languages. The DBMS 518 may access data represented in one or more data schemas and stored in any suitable data repository. Data stored in the datastore(s) 526 may include, for example, counter values, binary signal values, issue-to-issue delay mode indicators, threshold values, and so forth. External datastore(s) 526 that may be accessible by the computing device 502 via the DBMS 518 may include, but are not limited to, databases (e.g., relational, object-oriented, etc.), file systems, flat files, distributed datastores in which data is stored on more than one node of a computer network, peer-to-peer network datastores, or the like.

Referring now to other illustrative components of the computing device 502, the input/output (I/O) interface(s) 508 may facilitate the receipt of input information by the computing device 502 from one or more I/O devices as well as the output of information from the computing device 502 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device 502 or may be separate. The I/O devices may further include, for example, any number of peripheral devices such as data storage devices, printing devices, and so forth.

The I/O interface(s) 508 may also include an interface for an external peripheral device connection such as universal serial bus (USB), FireWire, Thunderbolt, Ethernet port or other connection protocol that may connect to one or more networks. The I/O interface(s) 508 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The computing device 502 may further include one or more network interfaces 510 via which the computing device 502 may communicate with any of a variety of other systems, platforms, networks, devices, and so forth. The network interface(s) 510 may enable communication, for example, with one or more other devices via one or more of the network(s).

It should be appreciated that the hardware logic/program modules depicted in FIG. 5 are merely illustrative and not exhaustive and that processing described as being supported by any particular module may alternatively be distributed across multiple modules, engines, or the like, or performed by a different module, engine, or the like. In addition, various program module(s), script(s), plug-in(s), Application Programming Interface(s) (API(s)), or any other suitable computer-executable code hosted locally on the computing device 502 and/or other computing devices accessible via one or more networks, may be provided to support functionality provided by the modules depicted in FIG. 5 and/or additional or alternate functionality. Further, functionality may be modularized in any suitable manner such that processing described as being performed by a particular module may be performed by a collection of any number of program modules, or functionality described as being supported by any particular module may be supported, at least in part, by another module. In addition, program modules that support the functionality described herein may be executable across any number of cluster members in accordance with any suitable computing model such as, for example, a client-server model, a peer-to-peer model, and so forth. Any of the functionality described as being supported by any of the modules depicted in FIG. 5 may be implemented, at least partially, in hardware, software, and/or firmware across any number of devices.

It should further be appreciated that the computing device 502 may include alternate and/or additional hardware, software, or firmware components beyond those described or depicted without departing from the scope of the disclosure. More particularly, it should be appreciated that software, firmware, or hardware components depicted as forming part of the computing device 502 are merely illustrative and that some components may not be present or additional components may be provided in various embodiments. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular logic module may, in various embodiments, be provided at least in part by one or more other modules. Further, one or more depicted modules may not be present in certain embodiments, while in other embodiments, additional modules not depicted may be present and may support at least a portion of the described functionality and/or additional functionality.

One or more operations of any of the methods 200-400 may be performed by a computing device 502 having the illustrative configuration depicted in FIG. 5, or more specifically, by hardware logic, software/firmware program modules, or the like executable on such a device. It should be appreciated, however, that such operations may be implemented in connection with numerous other device configurations.

The operations described and depicted in the illustrative methods of FIGS. 2-4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2-4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for dynamically adjusting an issue-to-issue delay mode of an instruction sequencing unit, the method comprising:
initializing the issue-to-issue delay mode to a bypassing mode;
identifying a plurality of instructions in an issue queue;
determining, for each of the plurality of instructions, whether the instruction is able to issue in the bypassing mode;
initializing a counter to a predetermined value;
decrementing the counter for each instruction able to issue in the bypassing mode;
incrementing the counter for each instruction not able to issue in the bypassing mode;
determining that the counter is greater than or equal to a threshold value; and
switching the issue-to-issue delay mode to a non-bypassing mode.

2. The computer-implemented method of claim 1, further comprising determining that each of the plurality of instructions is a respective floating point instruction.

3. The computer-implemented method of claim 1, wherein the counter is a first counter and the predetermined value is a first predetermined value, the method further comprising:
initializing a second counter to a second predetermined value;
determining that the issue-to-issue delay mode is set to the non-bypassing mode;
incrementing the second counter for each of one or more instruction cycles;
determining that the second counter equals a threshold reset value; and
switching the issue-to-issue delay mode back to the bypassing mode.

4. The computer-implemented method of claim 3, further comprising resetting the first counter to a third predetermined value.

5. The computer-implemented method of claim 1, further comprising:
identifying a critical instruction in the issue queue; and
switching the issue-to-issue delay mode to the bypassing mode such that the critical instruction can issue in the bypassing mode.

6. The computer-implemented method of claim 1, wherein the plurality of instructions is a first plurality of instructions and the threshold value is a first threshold value, the method further comprising:
identifying a second plurality of instructions in the issue queue;
determining, for each of the second plurality of instructions, whether the instruction is able to issue in the bypassing mode;
decrementing the counter for each instruction in the second plurality of instructions that is able to issue in the bypassing mode;
incrementing the counter for each instruction in the second plurality of instructions that is not able to issue in the bypassing mode;
determining that the counter is equal to a second threshold value that is less than the first threshold value; and
switching the issue-to-issue delay mode back to the bypassing mode.

7. The computer-implemented method of claim 1, wherein the plurality of instructions comprises at least two instructions having a source dependency there between.

8. A system for dynamically adjusting an issue-to-issue delay mode of an instruction sequencing unit, the system comprising:
at least one processor, wherein the at least one processor comprises an instruction sequencing unit (ISU) that includes:
first hardware logic configured to:
initialize the issue-to-issue delay mode to a bypassing mode;
identify a plurality of instructions in an issue queue; and
determine, for each of the plurality of instructions, whether the instruction is able to issue in the bypassing mode; and
second hardware logic configured to:
initialize a counter to a predetermined value;
decrement the counter for each instruction able to issue in the bypassing mode;
increment the counter for each instruction not able to issue in the bypassing mode;
determine that the counter is greater than or equal to a threshold value; and
switch the issue-to-issue delay mode to a non-bypassing mode.

9. The system of claim 8, wherein the first hardware logic is further configured to determine that each of the plurality of instructions is a respective floating point instruction.

10. The system of claim 8, wherein the counter is a first counter and the predetermined value is a first predetermined value, and wherein the ISU further includes third hardware logic configured to:
initialize a second counter to a second predetermined value;
determine that the issue-to-issue delay mode is set to the non-bypassing mode;
increment the second counter for each of one or more instruction cycles;
determine that the second counter equals a threshold reset value; and
switch the issue-to-issue delay mode back to the bypassing mode.

11. The system of claim 10, wherein the third hardware logic is further configured to reset the first counter to a third predetermined value.

12. The system of claim 8, wherein the ISU further includes third hardware logic configured to:
identify a critical instruction in the issue queue; and
switch the issue-to-issue delay mode to the bypassing mode such that the critical instruction can issue in the bypassing mode.

13. The system of claim 8, wherein the plurality of instructions is a first plurality of instructions and the threshold value is a first threshold value, wherein the ISU further includes third hardware logic configured to:
identify a second plurality of instructions in the issue queue;
determine, for each of the second plurality of instructions, whether the instruction is able to issue in the bypassing mode;
decrement the counter for each instruction in the second plurality of instructions that is able to issue in the bypassing mode;
increment the counter for each instruction in the second plurality of instructions that is not able to issue in the bypassing mode;
determine that the counter is equal to a second threshold value that is less than the first threshold value; and
switch the issue-to-issue delay mode back to the bypassing mode.

14. The system of claim 8, wherein the plurality of instructions comprises at least two instructions having a source dependency there between.

15. A computer program product for dynamically adjusting an issue-to-issue delay mode of an instruction sequencing unit, the computer program product comprising a storage medium readable by a processing circuit, the storage medium storing instructions executable by the processing circuit to cause a method to be performed, the method comprising:
initializing the issue-to-issue delay mode to a bypassing mode;
identifying a plurality of instructions in an issue queue;
determining, for each of the plurality of instructions, whether the instruction is able to issue in the bypassing mode;
initializing a counter to a predetermined value;
decrementing the counter for each instruction able to issue in the bypassing mode;
incrementing the counter for each instruction not able to issue in the bypassing mode;
determining that the counter is greater than or equal to a threshold value; and
switching the issue-to-issue delay mode to a non-bypassing mode.

16. The computer program product of claim 15, the method further comprising determining that each of the plurality of instructions is a respective floating point instruction.

17. The computer program product of claim 15, wherein the counter is a first counter and the predetermined value is a first predetermined value, the method further comprising:
initializing a second counter to a second predetermined value;
determining that the issue-to-issue delay mode is set to the non-bypassing mode;
incrementing the second counter for each of one or more instruction cycles;
determining that the second counter equals a threshold reset value; and
switching the issue-to-issue delay mode back to the bypassing mode.

18. The computer program product of claim 17, the method further comprising resetting the first counter to a third predetermined value.

19. The computer program product of claim 15, the method further comprising:
identifying a critical instruction in the issue queue; and
switching the issue-to-issue delay mode to the bypassing mode such that the critical instruction can issue in the bypassing mode.

20. The computer program product of claim 15, wherein the plurality of instructions is a first plurality of instructions and the threshold value is a first threshold value, the method further comprising:
identifying a second plurality of instructions in the issue queue;
determining, for each of the second plurality of instructions, whether the instruction is able to issue in the bypassing mode;
decrementing the counter for each instruction in the second plurality of instructions that is able to issue in the bypassing mode;
incrementing the counter for each instruction in the second plurality of instructions that is not able to issue in the bypassing mode;
determining that the counter is equal to a second threshold value that is less than the first threshold value; and
switching the issue-to-issue delay mode back to the bypassing mode.
